(19) United States
(12) Patent Application Publication
(10) Pub. No.: US 2021/0151267 A1
(43) Pub. Date: May 20, 2021

(54) TOUCH PAD STRUCTURE

(71) Applicant: Acer Incorporated, New Taipei City (TW)

(72) Inventors: Ting-Wen Pai, New Taipei City (TW); Wen-Chieh Tai, New Taipei City (TW); Cheng-Nan Ling, New Taipei City (TW); Chih-Chun Liu, New Taipei City (TW); Hung-Jen Su, New Taipei City (TW)

(73) Assignee: Acer Incorporated, New Taipei City (TW)

(21) Appl. No.: 16/905,921

(22) Filed: Jun. 19, 2020

Related U.S. Application Data
(60) Provisional application No. 62/937,806, filed on Nov. 20, 2019.

(30) Foreign Application Priority Data
Feb. 6, 2020 (TW) 109201326

(51) Int. Cl. H01H 21/18

(52) U.S. Cl. CPC H01H 21/18; G06F 1/1671; H01H 2231/002; H01H 2227/022

(57) ABSTRACT

A touch pad structure includes a touch pad, a dome switch, and a buffer film. The touch pad includes a fulcrum end and a moving end opposite to the fulcrum end, and the touch pad has an outer surface and an inner surface opposite to the outer surface. The dome switch is disposed at the moving end and connected to the inner surface of the touch pad. The dome switch includes a switch body and a convex portion protruding from the switch body. The buffer film is attached to the inner surface of the touch pad and the dome switch. The buffer film covers the dome switch and has a perforation, and the convex portion of the dome switch is located inside the perforation.

### CROSS-REFERENCE TO RELATED APPLICATION

This application claims the priority benefits of U.S. provisional application Ser. No. 62/937,806, filed on Nov. 20, 2019, and Taiwan patent application serial no. 109201326, filed on Feb. 6, 2020. The entirety of each of the above-mentioned patent applications is hereby incorporated by reference and made a part of this specification.

### BACKGROUND

### Technical Field

The disclosure relates to a touch structure, and in particular, to a touch pad structure applied to a notebook computer.

### Description of Related Art

Notebook computers have become an indispensable tool in modern lives or work due to strong processing performance and user portability. Generally, a notebook computer is composed of a display and a host. The host has computing, processing, and data accessing abilities, and the display is electrically connected to the host.

Specifically, the host mostly integrates physical operation interfaces, such as a keyboard and a touch pad, so that the user can operate the notebook computer easily. When the user presses or taps the touch pad, a dome switch (or referred to as a reed switch) on the touch pad is pressed by a force and is elastically deformed (e.g., collapsed), and sound may be produced due to deformation or impact on the touch pad. Therefore, how to reduce the sound produced by the touch pad during operation is an issue that needs to be resolved at present.

### SUMMARY

The disclosure provides a touch structure that can reduce sound produced during operation.

An embodiment of the disclosure provides a touch structure that includes a touch pad, a dome switch, and a buffer film. The touch pad includes a fulcrum end and a moving end opposite to the fulcrum end, and the touch pad has an outer surface and an inner surface opposite to the outer surface. The dome switch is disposed at the moving end and connected to the inner surface of the touch pad. The dome switch includes a switch body and a convex portion protruding from the switch body. The buffer film is attached to the inner surface of the touch pad and the dome switch. The buffer covers the dome switch, wherein the buffer film has a perforation, and the convex portion of the dome switch is located inside the perforation.

Based on the above, in the touch structure provided in one or more embodiments of the disclosure, the dome switch is integrated with a buffer design to reduce the sound generated during operation.

Several exemplary embodiments accompanied with figures are described in detail below to further describe the disclosure in details.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a touch pad structure according to an embodiment of the disclosure.

FIG. 2 is a schematic top view of the touch pad structure in FIG. 1.

FIG. 3 is a schematic cross-sectional view along a section line I-I of the touch pad structure in FIG. 2.

FIG. 4A is a schematic enlarged view of the area A in FIG. 3.

FIG. 4B is a schematic partially enlarged view of the buffer film in FIG. 4A.

FIG. 5 is a schematic bottom view of the touch pad structure in FIG. 1.

FIG. 6 is a schematic enlarged view of the area B in FIG. 5.

FIG. 7 schematically illustrates that a buffer film is unfolded according to another embodiment of the disclosure.

FIG. 8 schematically illustrates that a buffer film is unfolded according to still another embodiment of the disclosure.

### DESCRIPTION OF THE EMBODIMENTS

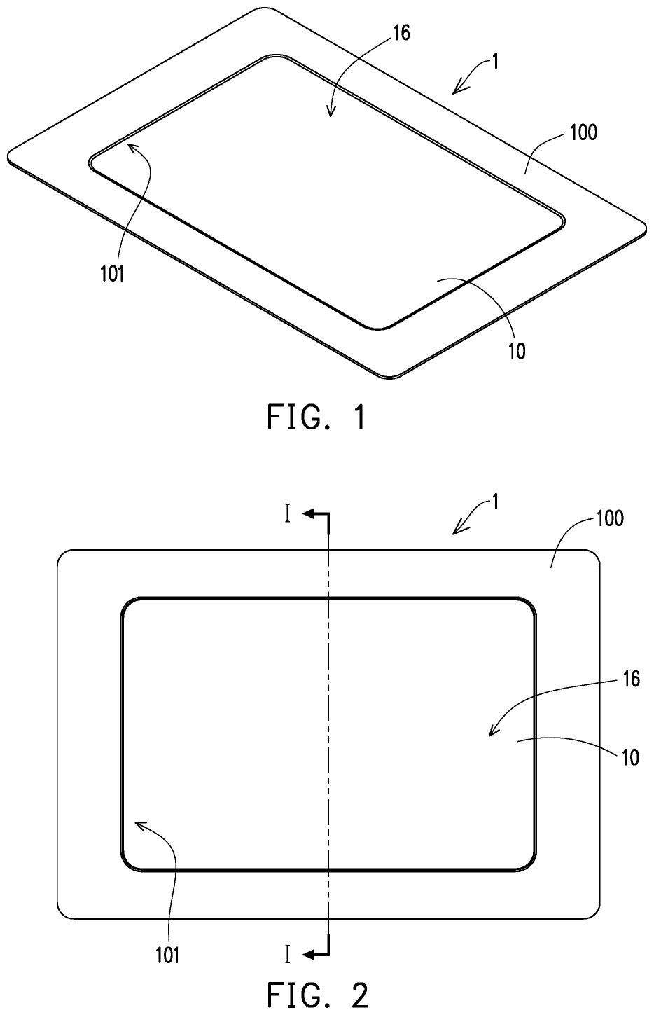

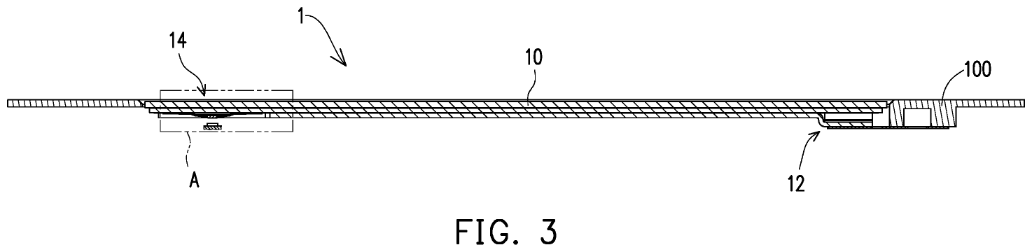

FIG. 1 is a schematic diagram of a touch pad structure according to an embodiment of the disclosure. FIG. 2 is a schematic top view of the touch pad structure in FIG. 1. FIG. 3 is a schematic cross-sectional view along a section line I-I of the touch pad structure in FIG. 2. With reference to FIG. 1 to FIG. 3, in the embodiment, a touch pad structure 1 may be integrated into a notebook computer for users to operate the notebook computer. To be specific, the touch pad structure 1 may be integrated into the casing 100 of a notebook computer or a docking station, wherein the touch pad structure 1 includes a touch pad 10, and the casing 100 has an opening 101. The touch pad 10 is located in and exposed by the opening 101 for user's fingers to slide on the touch pad 10 or press the touch pad 10.

On the other hand, the touch pad 10 includes a fulcrum end 12 and a moving end 14 opposite to the fulcrum end 12, wherein the fulcrum end 12 is connected to the casing 100, and the fulcrum end 12 serves as the rotation fulcrum of the touch pad 10. When the user exerts a force on the moving end 14, the moving end 14 rotates downward relative to the fulcrum end 12.

In particular, the touch pad structure 1 may also be integrated into a docking station for user to operate a smart phone or a tablet computer installed on the docking station.

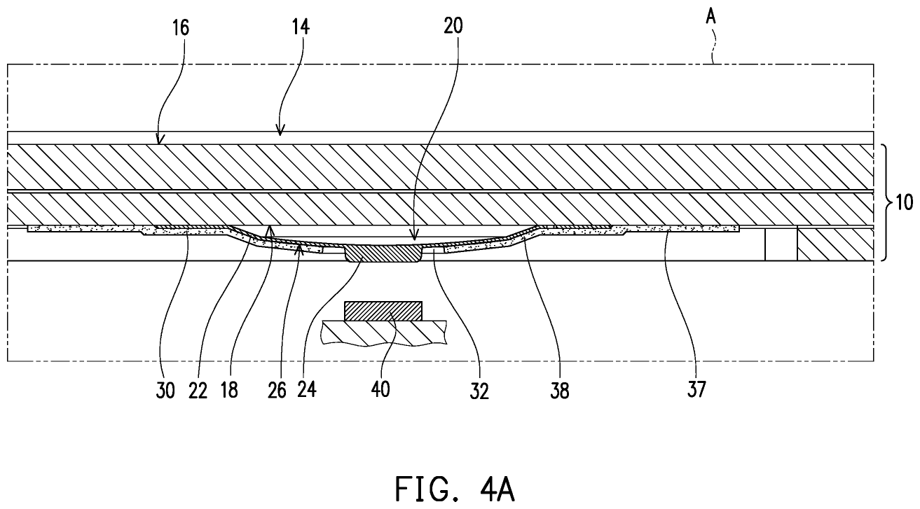

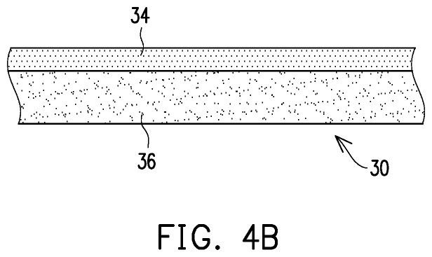

FIG. 4A is a schematic enlarged view of the area A in FIG. 3. With reference to FIG. 2, FIG. 3, and FIG. 4A, in the embodiment, the touch pad 10 has an outer surface 16 and an inner surface 18 opposite to the outer surface 16, and the outer surface 16 is exposed by the opening 101. In detail, the touch pad structure 1 further includes a dome switch 20 and a buffer film 30, and the dome switch 20 is disposed at the moving end 14 and connected to the inner surface 18 of the touch pad 10. The buffer film 30 is attached to the inner surface 18 of the touch pad 10 and the dome switch 20, and the buffer film 30 covers most of the dome switch 20.

For example, the dome switch 20 may be a metal reed configured to turn on circuits on the outer surface 18 of the touch pad 10 after the dome switch 20 is deformed by a force. On the other hand, the buffer film 30 has great elasticity and ductility and may be made of polyethylene terephthalate (PET), rubber, silicone, or other suitable materials. When the dome switch 20 is pressed by a force and is elastically deformed (e.g., collapsed), the buffer film 30 exerts a tension on the dome switch 20, so as to slow down the deformation speed (e.g., collapse speed) of the dome switch 20 and to avoid the excessive sound from being produced by the dome switch 20 due to rapid deformation or rapid impact on the touch pad 10.

In the embodiment, the dome switch 20 includes a switch body 22 and a convex portion 24 protruding from the switch body 22, wherein the switch body 22 has a surface 26 facing away from the touch pad 10, and the convex portion 24 protrudes from the surface 26. The buffer film 30 is attached to and covers most of the surface 26 of the switch body 22, and the convex portion 24 is exposed by the buffer film 30. Furthermore, the buffer film 30 has a perforation 32, and the convex portion 24 is located inside the perforation 32. For example, the convex portion 24 penetrates the perforation 32; that is, the thickness of the convex portion 24 is greater than the depth of the perforation 32 or the thickness of the buffer film 30.

In other embodiments, the thickness of the convex portion may be equal to the depth of the perforation or the thickness of the buffer film.

On the other hand, the touch pad structure 1 further includes a trigger boss 40 disposed inside the casing 100 and toward the inner surface 18 of the touch pad 10. Particularly, the trigger boss 40 is aligned to the convex portion 24 of the dome switch 20, and located on a movement path of the convex portion 24. When the user exerts a force on the moving end 14, the moving end 14 rotates downward relative to the fulcrum end 12, and the dome switch 20 approaches the trigger boss 40 and contacts the trigger boss 40 through the convex portion 24, so that the dome switch 20 is pressed by the force and elastically deformed (e.g., collapsed).

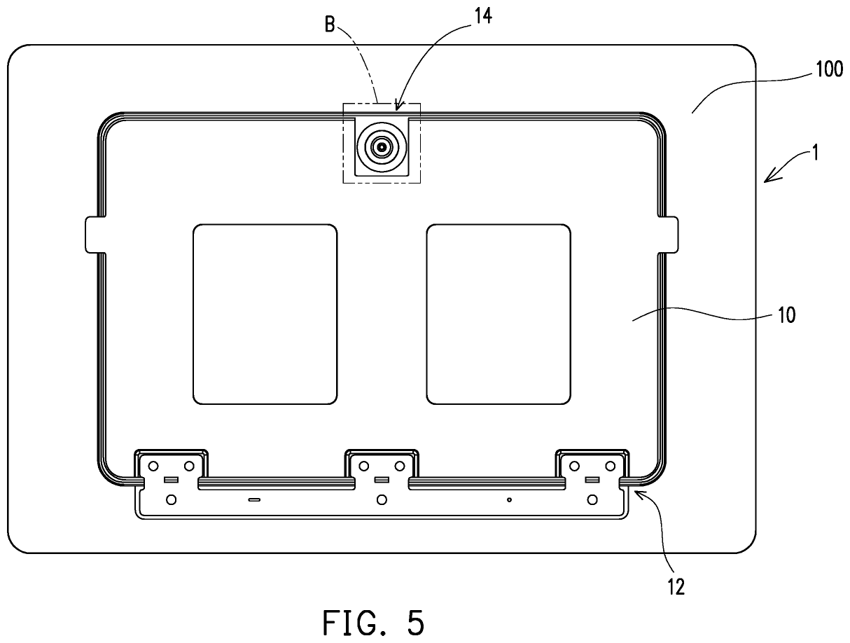

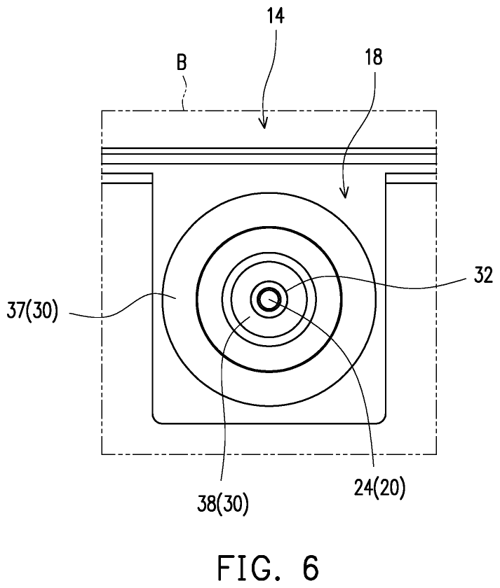

FIG. 4B is a schematic partially enlarged view of the buffer film in FIG. 4A. FIG. 5 is a schematic bottom view of the touch pad structure in FIG. 1. FIG. 6 is a schematic enlarged view of the area B in FIG. 5. With reference to FIGS. 4A and 4B, in the embodiment, the buffer film 30 includes an adhesive layer 34 and a buffer layer 36 connecting the adhesive layer 34, wherein the adhesive layer 34 may be a double-sided tape or constituted by adhesives, and the buffer layer 36 may be made of PET, rubber, silicone, or other suitable materials. The adhesive layer 34 is attached to the inner surface 18 of the touch pad 10 and the surface 26 of the switch body 22, wherein the buffer layer 36 is adhered and fixed to the inner surface 18 of the touch pad 10 and the surface 26 of the switch body 22 through the adhesive layer 34, and the adhesive layer 34 is located between the dome switch 20 and the buffer layer 36. It can be understood that the perforation 32 penetrates the adhesive layer 34 and the buffer layer 36.

Next, with reference to FIG. 4A, FIG. 5, and FIG. 6, in the embodiment, the buffer film 30 includes a first portion 37 and a second portion 38, and the first portion 37 surrounds the second portion 38. In detail, the first portion 37 is attached to the inner surface 18 of the touch pad 10, and the second portion 38 is attached to and covers most of the surface 26 of the switch body 22. The perforation 32 is located at and penetrates the second portion 38.

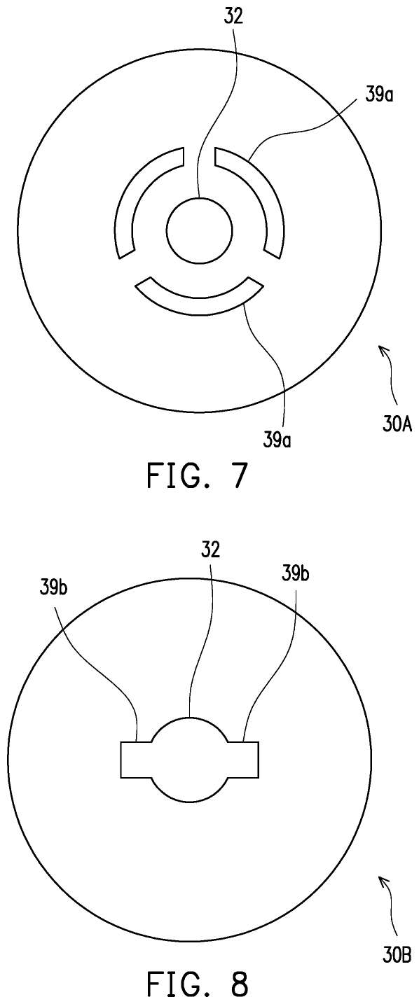

FIG. 7 schematically illustrates that a buffer film is unfolded according to another embodiment of the disclosure. With reference to FIG. 7, the buffer film 30A provided in the embodiment may be applied to the touch pad structure 1 provided in the above embodiment. In comparison with the buffer film 30 provided in the above embodiment, the buffer film 30A provided in the embodiment further has at least one through slot 39a, and the through slot 39a is located on a side of the perforation 32. In detail, the through slot 39a may be an arc-shaped slot, and the number of the through slot 39a may be plural. The through slots are separate from each other and surround the perforation 32. The through slots 39a may serve to make the buffer film 30A more prone to elastic deformation, so as to prevent the buffer film 30A from applying excessive tension to the dome switch 20 provided in the above embodiment, which may hinder the elastic deformation of the dome switch 20 provided in the embodiment.

FIG. 8 schematically illustrates that a buffer film is unfolded according to still another embodiment of the disclosure. With reference to FIG. 8, the buffer film 30B provided in the embodiment may be applied to the touch pad structure 1 provided in the above embodiment. In comparison with the buffer film 30 provided in the above embodiment, the buffer film 30B provided in the embodiment further has at least one through slot 39b, and the through slot 39b is located on a side of the perforation 32. In detail, the through slot 39b may be a rectangular slot, wherein the number of the through slot 39b may be plural. The through slots may be connected to the perforation 32. The through slots 39b may serve to make the buffer film 30B more prone to elastic deformation, so as to prevent the buffer film 30B from applying excessive tension to the dome switch 20 provided in the above embodiment, which may hinder the elastic deformation of the dome switch 20 provided in the embodiment.

In summary, in the touch structure provided in one or more embodiments of the disclosure, the dome switch is integrated with a buffer design to reduce the sound generated during operation. To be specific, the dome switch is covered by the buffer film, and the buffer film is extended to the touch pad. Therefore, when the dome switch is pressed by a force and is elastically deformed (for example, collapsed), the buffer film exerts a tension to the dome switch, thereby slowing down the deformation speed (for example, collapsed speed) of the dome switch to prevent excessive sound from being produced by the dome switch due to rapid deformation or rapid impact on the touch pad.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A touch pad structure, comprising:
a touch pad, comprising a fulcrum end and a moving end opposite to the fulcrum end, the touch pad having an outer surface and an inner surface opposite to the outer surface;
a dome switch, disposed at the moving end and connected to the inner surface of the touch pad, the dome switch comprising a switch body and a convex portion protruding from the switch body; and
a buffer film, attached to the inner surface of the touch pad and the dome switch and covering the dome switch, wherein the buffer film has a perforation, and the convex portion of the dome switch is located inside the perforation.

2. The touch pad structure according to claim 1, wherein the switch body has a surface facing away from the touch pad, the convex portion protrudes from the surface, and the buffer film is attached to and covers the surface.

3. The touch pad structure according to claim 1, wherein the convex portion penetrates the perforation.

4. The touch pad structure according to claim 1, wherein the buffer film comprises an adhesive layer and a buffer layer connecting the adhesive layer, the adhesive layer is attached to the inner surface of the touch pad and the dome switch, and the adhesive layer is located between the dome switch and the buffer layer.

5. The touch pad structure according to claim 1, wherein the buffer film further has at least one through slot, and the at least one through slot is located on a side of the perforation.

6. The touch pad structure according to claim 5, wherein the at least one through slot surrounds the perforation.

7. The touch pad structure according to claim 5, wherein the at least one through slot is connected to the perforation.

8. The touch pad structure according to claim 1, further comprising:
a trigger boss, facing the inner surface of the touch pad, the trigger boss being aligned to the convex portion of the dome switch.

9. The touch pad structure according to claim 8, wherein the trigger boss contacts the convex portion of the dome switch.

10. The touch pad structure according to claim 1, wherein the buffer film comprises a first portion and a second portion, the first portion surrounds the second portion, the first portion is attached to the inner surface of the touch pad, the second portion is attached to and covers the dome switch, and the perforation penetrates the second portion.
